(19) United States
(12) Patent Application Publication
(10) Pub. No.: US 2002/0108953 A1
(43) Pub. Date: Aug. 15, 2002

(54) Measuring cup lid

(76) Inventor: Charles Goralnik, St. Louis, MO (US)

Correspondence Address: Paul M. Denk, 763 South New Ballas Road, St. Louis, MO, 63141, US

(21) Appl. No.: 10/039,089

(22) Filed: Jan. 2, 2002

Related U.S. Application Data
(60) Provisional application No. 60/259,047, filed on Jan. 2, 2001.

(51) Int. Cl. B65D 41/56; A47J 39/00; B65D 1/24

(52) U.S. Cl. 220/212; 220/780; 220/522

(57) ABSTRACT

A beverage cup lid, having integrally therein a series of compartments, of varying but more precise sizes, to furnish concise measuring and dispensing of various flavoring agents into the cup contained beverage, whether it be a tea, coffee, or the like.

### BACKGROUND OF THE INVENTION

Sometimes various beverages have been dispensed into, and served within either paper, polymer, or related cups, by the restaurant, coffee shop, market, soda and coffee dispensing machines, and the like. In most instances, after the beverage has been deposited into the cup, a lid is available for clasping onto the top of the cup, to provide it with closure. And, in many instances, such lids have tear away portions, connected by perforation, which allows for opening only of the mouthpiece portion of the lid and cup, to allow the beverage to be consumed therefrom. Generally, this is the extent to which beverage cups, and their accompanying polymer lid, has been advanced, and used predominantly throughout commerce.

The only other modification made to such a lid is disclosed in U.S. Pat. No. 5,431,276, as assigned to Quik-Lid, Inc. In the patent, it defines an apparatus having a lid, with an external rim, an internal rim, the internal rim including a series of dividers, in order to create a plurality of compartments for holding additives, such as individually packaged sugar, creamers, sweeteners, and any of the other condiments that may be used in conjunction with the servicing and consumption of a cup of coffee, tea, or the like. But, in this patent, not only are the condiments sealed in their individual dividers, but each divider compartment includes a plunger, that may penetrate the bottom of the cover, to allow for dispensing of its individual contents into the cup, through the application of pressure applied to the lid forcing the plunger to puncture the bottom of the compartment, between the dividers, for flavoring the contained beverage within the cup arranged therebelow.

This is a rather complex type of lid, formed for holding individual condiments therewith, and if any condiment is not used, then it, and its cost, have been wasted, due to its lack of usage.

### SUMMARY OF THE INVENTION

This invention contemplates the molding integrally within the lid for a cup, such as a cup for any beverage like soda, tea, coffee, or the like. But, generally, the lid is formed having a series of integral compartments, that may function in the manner as a measuring cup, and into which select condiments may be applied, such as sugar, cream, or the like, for coffee, or sugar, lemon, cream, for tea, whether it be iced or hot tea, or coffee, to allow the purchaser to achieve precise measurement of the individual flavor, before pouring the same into the contained beverage enclosed in the cup arranged therebelow.

It is, therefore, the principal object of this invention to provide for an integral type measuring cup within the lid for a container, such as a cup, and which when applied provides precise measurement for the type of condiment or spice or flavor, plus sweetener, that the consumer may wish to add to their particular beverage, whether it be ice tea, hot tea, or coffee.

Another object of this invention is to provide for the precise integration of measuring like cups into the upper surface of the lid for a beverage cup, in preparation for flavoring the cup contained beverage.

It is yet another object of this invention to provide measuring type means, even applied to the underside of a beverage cup lid, and which can be used for receiving, measuring, containing, and eventually discharging into the cup of beverage, in preparation for its consumption.

These and other objects may become more apparent to those skilled in the art upon review of the summary as provided herein, and upon undertaking a study of the description of its preferred embodiment.

This invention contemplates the formation of, generally, polymer formed lid for a beverage cup, and which has integrally molded therein, particularly in the concave portion of the formed lid, precisely sized compartments for reception of any spice, flavor, sweetener, or creamery, therein, in preparation for its dispensing into the cup of coffee, tea, or the like. These compartments may be integrally molded, into the lid as formed, and may undertake any shape required, such as circular, semicircular, square, rectangular, or the like, the object being to provide for precise measurements of the type of flavoring normally added, whether it be a compartment having a capacity the size of a teaspoon, or a compartment having sufficient size to allow for the pouring, for example, of a cream, whole milk, half-and-half, or no fat cream, as can be understood.

### BRIEF DESCRIPTION OF THE DRAWING

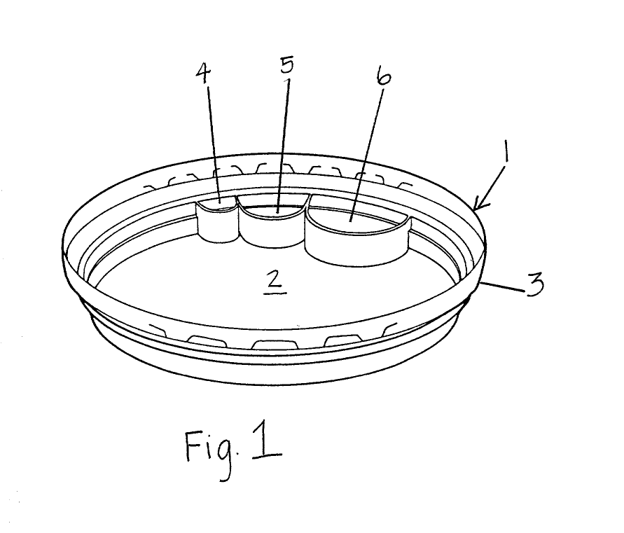

In referring to the drawing, FIG. 1 is a perspective view of the measuring cup lid of this invention.

### DESCRIPTION OF THE PREFERRED EMBODIMENT

In referring to FIG. 1 of the drawings, therein can be seen a lid 1 for a cup or container, such lids normally are fabricated from a polymer, vacuum molded, or the like, and include a closure base 2 having a rim 3, in this particular instance, which may insert into the cup, and become tightly secured, in a sealing relationship, with the upper interior rim of the cup, to provide for closure of the same once a beverage has been dispensed or poured therein. Or, the shape and configuration of this cup may further be of the standard type of lid, available in the art, wherein the upper edge of the lip may curl over, from the molding process, and then engage into closure upon the upper lip or edge of the cup, to provide sealing.

In this particular instance, as can be noted, this lid is formed as a concaved type structure, and molded integrally into the inner surface of the lid are a series of compartments 4, 5 and 6, as noted. These compartments have specific volumetric capacity to them, so that they can be used for providing measurement to any of the condiments that may be added to the beverage, as previously reviewed, for example compartment 4 may be of a capacity assimilating a spoonful of a flavoring agent, such as sugar. Compartment 5 may be a one-half ounce capacity for measuring any liquid, such as a cream, milk, or the like, that may be added to a cup of coffee. Compartment 6 may be a full one ounce capacity, for the measurement of cream, where a larger amount of cream may be added, rather precisely, to the dispensed beverage. These types of measurements, while they may not be critical for the routine user, may be quite pertinent if the consumer of the beverage, for example, may be suffering from a particular disease, such as diabetes, and needs to very precisely measure the amount of flavoring or condiments that may be added to the beverage, whether it be tea, coffee, or the like.

In addition, the concavity to the cup may be applied or formed at its bottom side, and having the same compartments 4 through 6 integrally molded therein, while the outer rim 3 of the lid may be curled over, to yet be available for sealing onto the upper edge of the cup, when used. In either event, and regardless whether the concavity of the lid is formed on the upper surface, as noted in FIG. 1, or molded into the bottom surface of the lid, if the concavity is formed thereat, the lid is still intended to be one that seals onto the upper lip of a cup, and provide these measuring compartments that may be initially used, for adding particularly flavoring agents to the beverage, before the lid is sealed in place.

Or, it is just as likely that the beverages may be dispensed with one of these lids applied thereon, and the purchaser can simply remove the lid, apply the compartments for the measurement of any flavoring agents, proceed to perform such, and then reapply the lid, if the cupped beverage is to be transferred to another location, or perhaps even conveyed in a vehicle, until the consumer arrives at work, or other location.

There is another feature to this invention, which is actually an attribute that can be attained by the supplier, when this type of a fabricated lid may be for a beverage. For example, the well-known Starbucks Coffee Co. could fabricate lids in this manner, and the purchaser of a cup of coffee could measure more precisely, at the dispensing counter, the type of cream, milk, sugar, and the like, to add to the coffee, and do so in a much more concise manner. As an alternative, without such a measuring device, the consumer frequently pours an excessive amount of cream, or sugar, into their cup of coffee, far in excess of what is needed, or what the consumer normally wants. Hence, a company, such as Starbucks, may save substantial money, over a period of time, by providing more precise measurements to the usage of such condiments, when measured by the consumer himself/herself. Furthermore, the provider can eliminate the need to buy the more expensive individual serving packets, of cream, non-milk creamers, sugar, and the like, for use for addition to any beverage. Furthermore, fresh type of flavoring agents, such as sugar, can be added to the dispensed beverage, and avoid the problem that frequently occurs when you use one of these sugar dispensers, which may many times lump up, and does not pour sugar consistently into the beverage.

Obviously, the supplier could furnish spoons, plastic spoons, or the like, for measuring such portions, but this also can be expensive, and furthermore, maintaining sanitation becomes more difficult.

Thus, the concept of this invention is to integrate a measuring spoon, or compartment, into the plastic lid for the cup itself, provide a series of serving-like cups, integrally formed into the lid, for usage. Thus, the plastic lid for each beverage contains several of these compartmentalized or indented type areas, even on the underside, each marked with a specific volumetric capacity, whether it be a half teaspoon, one teaspoon, one and one-half teaspoons, which may be used at the desire of the customer, to provide for much more precise measurement. The customer would simply remove the top from the beverage container, which the customer would have to do anyway when they add any cream or sugar to the coffee, tea, or the like, but in this instance, provide for precise measurement, for addition into the beverage, for immediate and more precise application and usage.

As previously stated, this procedure, utilizing this particular invention, would provide a much more precise method for the addition of such flavoring into a beverage, than to just bulk pour any cream or sugar from a larger container, into the beverage, as frequently done. Hence, utilizing this lid should prevent the wasting of such flavoring agents, as through over usage.

Variations or modification to the subject matter of this invention may occur to those skilled in the art upon reviewing the disclosure as provided herein. Such variations, if within the spirit of this development are intended to be encompassed within the scope of the invention as described herein. The invention, as specifically described herein, and as illustrated in the drawing, are set forth for illustrative purposes only.

I claim:

1. A measuring cup lid for use for application to the upper end of a cup of the type used for holding beverages, said cup lid being of the type that pressure fits upon the upper lip of the cup to which it is applied, said cup lid having a concavity formed of its upper surface, a closure base, forming an upper surface, and a rim around the closure base extending upwardly thereof, and providing for the said formed concavity, there being a series of compartments integrally formed upon the upper surface of the closure base, said compartments being specific volumetric capacity to provide for the measurement of any condiments that may be added to the beverage upon consumption, wherein a condiment may be applied within at least one of said compartments to provide for its measuring, before pouring into the beverage contained within the said cup.

2. The cup lid of claim 1 wherein the compartments formed having upwardly extending sides, and integrally formed with the rim of the cup lid, to form each said compartment.

3. The cup lid of claim 2 wherein there are three compartments formed extending upwardly from the closure base and integrated into the structure of the cup lid rim during fabrication.

4. The cup lid of claim 3 wherein the measuring cup lid is formed of a polymer.

5. The measuring cup lid of claim 4 wherein the cup lid rim inserts and secures within the beverage cup during usage.

6. The measuring cup lid of claim 4 wherein the rim has a curled over lip, and the lip engages into closure upon the upper edge of the cup during usage.

7. The measuring cup lid of claim 3 wherein each compartment is at least partially angular in configuration.

8. The measuring cup lid of claim 3 wherein each compartment is multi sided.
